(19) United States
(12) Patent Application Publication
(10) Pub. No.: US 2021/0298126 A1
(43) Pub. Date: Sep. 23, 2021

(54) NANOPHOTONIC INFRARED THERMAL EMITTERS

(71) Applicant: Foshan Huikang Optoelectronic Technology Co., Ltd., Foshan (CN)

(72) Inventors: Yongkang GONG, Foshan (CN); Kang LI, Foshan (CN); Bo ZHANG, Foshan (CN); Nigel Joseph COPNER, Foshan (CN); Dun QIAO, Foshan (CN)

(21) Appl. No.: 16/826,794

(22) Filed: Mar. 23, 2020

(51) Int. Cl. H05B 3/28; H05B 3/03; C01B 33/12; C01G 53/00

(52) U.S. Cl. CPC H05B 3/283; H05B 3/03; C01P 2006/32; C01G 53/00; C01B 33/12

(57) ABSTRACT

Provided is an infrared thermal emitter, which includes a first Bragg Grating layer comprising a first film and a second film stacked alternately, wherein the first film and the second film has a refractive index difference greater than 1.5; a second Bragg Grating layer including a film of silicon and a film of chromium stacked in a structure of (Si/Cr/Si)ⁿ, where n is an integer and represents a number of repeating period; and a heater layer; wherein the first Bragg Grating layer, second Bragg Grating layer and the heater layer are stacked sequentially from top on down. The infrared thermal emitters have unique advantage of greatly enhancing infrared light emissivity and significantly suppressing visible light radiation simultaneously.

### FIELD OF TECHNOLOGY

The following relates to the filed of electric heating, particularly, it relates to a infrared thermal emitter.

### BACKGROUND

Space heating is a huge source of energy consumption in cooler climates. In the UK, for instance, energy consumption for space heating are 28,728 and 10,084 thousand tons of oil equivalent in domestic and service sectors, which accounts for over 50% of total energy use. New approaches to energy efficiency heating are key to reduce fuel poverty to aid our society in transition to low carbon economy. Thermal insulation, solar energy, green buildings are important technologies to reduce energy consumption to keep warm in buildings, but space heating is more appealing if we are looking for affordable, quick and substantial energy savings for the existing buildings. In contrast to well established air space heating technologies (i.e., heat is generated by at least one of electricity and gas and dissipates into air) that is very inefficient as it transfers heat to the whole space by convection, infrared heating is more attractive as it heats objects locally and instantly without having to warm up air in the whole space and thus can consume less energy. Particularly, Infrared heating is ideal for outdoor heating where at least one of gas and electricity air heating is impossible. Moreover, infrared light provides gentle, comfortable and healthy heating as it warms objects in the same manner as natural sunlight—when infrared light strikes human body, it penetrates skin and is absorbed by water molecules that constitute 70% of our body, making molecules vibrate and thus raising body temperature from deep inside. Infrared light has added advantages of dissolving harmful substances accumulated in body and offering various health and beauty benefits such as increasing blood circulation, facilitating wound healing and relieving pain etc. Tremendous research efforts have been made toward infrared heating sources and several technologies have been developed over the past decades. The physical origin of infrared heating is graybody radiation, i.e., heating panel is heated to elevated temperature by electricity to radiate infrared light waves. The total radiated light power is determined by P=A*ε(λ)*σ*T⁴, where A, ε(λ), and T are the size, temperature and emissivity of the heating panel, respectively. σ is Stefan-Boltzmann constant. Therefore, electrical and optical properties of the heating panel materials play a crucial role in infrared heating. Current commercial infrared panels, typically made of refractory metals such as tungsten, nichrome alloys, ceramic materials etc, have two major issues that have inhibited the market penetration to industry and homeowners: dazzling glare and low electric-light conversion efficiency. Glare occurs due to strong radiation in visible wavelengths, which not only causes severe light pollution but also wastes energy. Low conversion efficiency arises from low optical emissivity ε(λ) of infrared panels at Mid-infrared. Enhancing infrared heating performance relies on material innovation of increasing infrared emissivity so that light radiation dominates heat convection. A new infrared thermal emitter with higher electric-light is urgently required.

### SUMMARY

The present disclosure has been made to address the above-mentioned problems and disadvantages, and to provide at least the advantages described below.

According to one aspect, an nanophotonic infrared thermal emitter comprises a first Bragg Grating layer comprising a first film and a second film stacked alternately, wherein the first film and the second film has a refractive index difference greater than 1.5; a second Bragg Grating layer comprising a film of silicon and a film of chromium stacked in a structure of (Si/Cr/Si)ⁿ, where n is an integer and represents a number of repeating period; and a heater layer; wherein the first Bragg Grating layer, second Bragg Grating layer and the heater layer are stacked sequentially from top to down.

According to another aspect, an infrared thermal emitting system comprises a nanophotonic infrared thermal emitter comprising a first Bragg Grating layer comprising a first film and a second film stacked alternately, wherein the first film and the second film has a refractive index difference greater than 1.5, a second Bragg Grating layer comprising a film of silicon and a film of chromium stacked in a structure of (Si/Cr/Si)ⁿ, where n is an integer and represents a number of repeating period; a heater layer; an electrode connected to either of the two sides of the heater layer; and a substrate; wherein the first Bragg Grating layer, second Bragg Grating layer, the heater layer and the substrate are stacked sequentially from top to down.

According to a further aspect, an infrared heating method comprises

providing, a nanophotonic infrared thermal emitter, comprising
a first Bragg Grating layer comprising a first film and a second film stacked alternately, wherein the first film and the second film has a refractive index difference greater than 1.5,
a second Bragg Grating layer comprising a film of silicon and a film of chromium stacked in a structure of (Si/Cr/Si)ⁿ, where n is an integer and represents a number of repeating period, and
a heater layer;
wherein the first Bragg Grating layer, second Bragg Grating layer and the heater layer are stacked sequentially from top to down; and
   supplying, an electric current to the heater layer.

### BRIEF DESCRIPTION OF THE DRAWINGS

Some of the embodiments will be described in detail, with reference to the following figures, wherein like designations demote like members, wherein:

FIG. 1 shows a perspective view of the infrared thermal emitter of one embodiment according to embodiments of the invention;

FIG. 2 shows a scanning electron microscope image of cross section of the infrared thermal emitter of another embodiment according to embodiments of the invention;

FIG. 3 shows a photonic bandgap of the first Bragg grating layer;

FIG. 4 shows an experimental and simulated transmissivity spectra of the infrared thermal emitter;

FIG. 5(a) shows characteristic impedance difference |Z_{AITE}-Zₐᵢᵣ| of the infrared thermal emitter;

FIG. 5(b) shows emissivity spectrum of the infrared thermal emitter of the infrared thermal emitter in comparison with refractory metal thermal emitters of tungsten, Nickle and chromium;

FIG. 6(a) shows directional spectral emissivity ε(θ, λ) by calculating spectral absorptivity for both TE and TM polarization respectively;

FIG. 6(b) shows directional spectral emissivity ε(θ, λ) by calculating spectral absorptivity for both TE and TM polarization respectively;

FIG. 7 shows the calculated and measured emissivity spectra at different angle;

FIG. 8(a) illustrates the measured radiation intensity in relation to the wavelength at various temperature due to different input electric power;

FIG. 8(b) illustrates the calculated spectral radiance of the infrared thermal emitter (solid line) and blackbody (dotted line) in relation to wavelength at various temperature from room temperature to 500K;

FIG. 9 shows the relationship between the input electric power and the temperature; and

FIG. 10 shows calculated spectra radiance at temperature 800K and 1200K, respectively.

### DETAILED DESCRIPTION

A detailed description of the hereinafter-described embodiments is presented herein by way of exemplification and not limitation with reference made to the Figures. A more complete understanding of the present embodiment and advantages thereof may be acquired by referring to the following description taken in conjunction with the accompanying drawings, in which like reference numbers indicate like features.

It should be noted that, as used in this specification and the appended claims, the singular forms “a”, “an” and “the” include plural meanings, unless the context clearly dictates otherwise.

The terms “top”, “down”, “below”, and “on” are only used to explain the relative position instead of the absolute position relationship. For example, if one subject is on top of the other, it will be under the other one after they are upturned.

When it refers to the “(first film/second film)^{m}”, it includes both the (first film/second film)^{m} and (second/first film)^{m}, without limit the coating sequences.

The present disclosure provides an infrared thermal emitter. Referring to FIG. 1, an exemplary embodiment of the infrared thermal emitter according to the present disclosure is shown. A first Bragg Grating layer 1, a second Bragg Grating layer 2, a heater layer 3 and a substrate 4 are stacked sequentially from up to down. These layers can be fabricated through any common means in the field. For example, the multiple thin films of the thermal emitters are fabricated by electron-beam evaporation of the constituent materials onto planar polished quartz substrate. The figure is only shown for explanation, and the shape, size and scale, etc., illustrated in the figure are only used for an exemplary explanation without any limitation. The first Bragg Grating layer 1, second Bragg Grating layer 2, heater layer 3 and substrate 4 are shown to be rectangular, however, they can be any suitable shape according to actual requirement. For example, they may be rounded, elliptical, or triangular, etc. The infrared thermal emitter is presented as a mirror image, because the structure has a broadband photonic bandgap in visible regime. an electrode (not shown), for example, a conductive silver paste, may be connected to either of the two sides of the heater layer for power connection. The thickness of each layer is measured with an in-situ quartz crystal monitor during material evaporation. Imaging of film thickness is also performed by scanning electron microscope (SEM) scanning of the cross sections of the fabricated samples.

The heater layer 3 is used to generate Joule heat to heat the first Bragg Grating layer 1 and the second Bragg Grating layer 2 when voltage is applied to the heater layer. The heater layer is preferably designed to has a larger surface area comparing to the first and second Bragg Grating layers as shown in FIG. 1, and this is advantageous for connecting to electricity. Metal with high resistance is preferable for the heater layer, comprising but not limited to refractory metal. In one embodiment, nickel-chromium alloy is selected to form the heater layer. Preferably, Ni₈₀Cr₂₀ is used to form the heater layer. An electric current is applied to either side of the film of Ni₈₀Cr₂₀ to generate Joule heat, whereby the temperature of the thin film structure will be raised. Ni₈₀Cr₂₀ has high resistance for effective Joule heat generation and also acts an optical reflective layer and allows no transmitted light energy. The thickness of the heater layer does not affect optical properties as long as it is thicker than hundreds of nanometers, but it varies the thermal performance as it determines structure electrical resistance. Preferably, the heater layer has a thickness of more than 100 nm, more preferably, more than 150 nm, preferably, more than 200 nm, preferably more than 250 nm, preferable, 300 nm, for the film of nickel-chromium alloy Ni₈₀Cr₂₀.

The first Bragg Grating layer 1 is configured to depress glare, wherein a first film and a second film are alternately stacked, and materials with high refractive index difference, for example, greater than 1.5, in the first Bragg Grating layer 1 are applied to give wider photonic bandgap. It is recommended to use Si-based dielectric materials, the refractive index of which is smaller than 1.5, such as silicon dioxide (SiO₂), as the first film, and use semiconductor materials, the refractive index of which is greater than 3, such as silicon (Si), as the second film. Either of the first film or the second film can be applied on the top. For example, one first film is applied on the top, one second film is applied to a bottom of the first film, and another first film is applied to a bottom of the second film . . . and so on. For another example, one second film is applied on the top, one first film is applied to a bottom of the second film, and another second film is applied to a bottom of the first film . . . and so on. Preferably, the film of Sift is applied on the top if Sift is used as the second film and Si is used as the first film, whereby the Sift film can protect the whole structure from thermal oxidation. In one embodiment, the first Bragg Grating layer has odd layers. In another embodiment, the first Bragg Grating layer has even layers and has a dual-film structure as a unit layer. The dual-film structure consists of one film of silicon dioxide and one film of silicon. Films of SiO2 and Si are repeatedly coated to form a structure of (SiO2/Si)^{m} or (Si/SiO2)^{m}.

By tailoring their thickness, a photonic bandgap with high reflectivity covering the whole visible wavelengths at broad angle of incidence can be achieved. Preferably, the first film has a thickness from 70 to 100 nm, more preferably, a thickness of 90 nm. Preferably, the film of second film has a thickness from 25 to 50 nm, more preferably, a thickness of 35 nm.

As light at wavelength larger than 1.4 μm experiences higher absorption by human body and delivers more efficient heat, it is essential to enhance absorption spectrum at wavelengths >1.4 μm as broad as possible. A second Bragg Grating layer 2 placed between the first Bragg Grating layer 1 and the alloy layer 3 increases absorption/emission by minimizing characteristic impedance difference |Zₑₘᵢₜₜₑᵣ−Zₐᵢᵣ| as to reduce light reflection. Zₐᵢᵣ and Zₑₘᵢₜₜₑᵣ are characteristic impedance of air and the infrared thermal emitter disclosed in the disclosure, respectively. The second Bragg Grating layer has a triple-film structure of (Si/Cr/Si)ⁿ, where n represents a number of repeating period; and every unit layer comprises two films of silicon and a film of chromium sandwiched therebetween. Cr material in BG2 not only plays a key role for impendence matching due to its optical dispersion and loss properties at infrared, but also acts as an adhesion layer.

According to Gong, Y K. etc., Coherent emission of light using stacked gratings, Phys. Rev. B. 2013, 87, 205121. Zₑₘᵢₜₜₑᵣ can be obtained by following recursive relation:

$${ξ}_{k + 1} = {Z}_{k + 1} \frac{{ξ}_{k} - i {Z}_{k + 1} tanh ( {β}_{k + 1} {d}_{k + 1} )}{{Z}_{k + 1} - i {ξ}_{k} tanh ( {β}_{k + 1} {d}_{k + 1} )} , \qquad ( 1 )$$

where k is integral, βₖ is wave vector and dₖ is thickness of the k^{th} layer from top layer, respectively. The closer the value of |Zₑₘᵢₜₜₑᵣ−Zₐᵢᵣ| is to zero, the absorptivity/emission will be achieved. According to above formula (1), Zₐᵢᵣ=ζ₀ is the characteristic impedance for air, and Zₑₘᵢₜₜₑᵣ=ζ₂ₘ₊₃ₙ₊₁ is the characteristic impedancen for the infrared thermal emitter. Here, m and n represent the number of repeating periods of the first Bragg Grating layer 1 and the second Bragg Grating layer 2 respectively. Preferably, m is from 1 to 7, More preferably, m is from 3 to 6. Most preferably, m is 4. Preferably, n is selected from 4 to 8, more preferably, n is 6. Thickness is a critical factor for the emission effect, in the second Bragg Grating layer, preferably the film of silicon has a thickness from 80 to 100 nm, more preferably a thickness of 90 nm. Preferably, the film of chromium has a thickness from 3 to 7 nm, more preferably a thickness of 5 nm.

A substrate 4 is configured under the heater layer. Preferably, a thermal insulator substrate is provided. In one embodiment, a silicon dioxide substrate is used, and make the generated Joule heat flow to the first Bragg Grating layer 1 and the second Bragg Grating layer 2 to raise their temperature. When used, an electric current is connected to the heater layer 3, and the heater layer will be heated to elevated temperature due to this high resistance, thus infrared light waves without glare will be obtained.

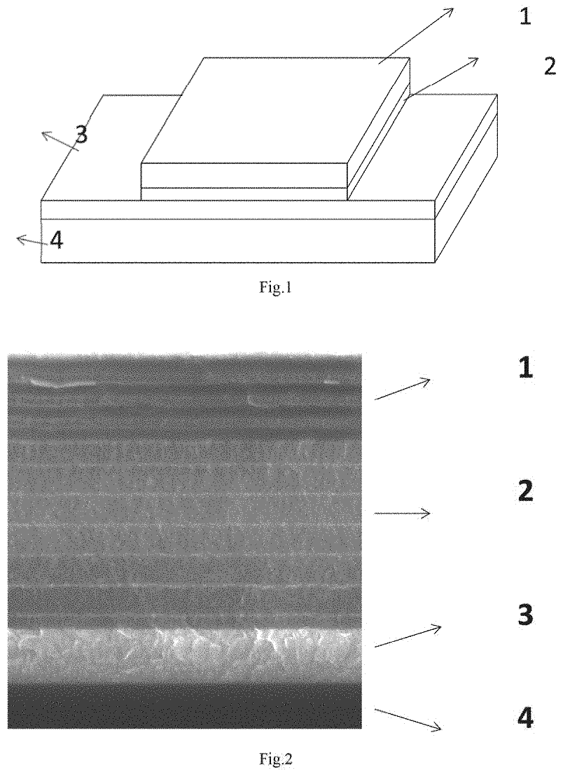

In one embodiment, an infrared thermal emitter comprising a silicon dioxide substrate 4; a heater layer 3 made of Ni₈₀Cr₂₀ in a thickness of 300 nm; a second Bragg Grating layer 2 with a structure of (Si/Cr/Si)⁶ wherein the layer thickness of Si and Cr are 90 nm and 5 nm respectively; and a first Bragg Grating layer 1 with a structure of (SiO₂/Si)⁴, wherein the thickness of SiO2 and Si are 90 nm and 35 nm respectively, is provided and called as AITE hereinafter. As can be seen from FIG. 2 that, the first Bragg Grating layer 1, the second Bragg Grating layer 2, the heater 3 and the substrate 4 are stacked from top to down. Some experiments are performed to test the performance of AITE.

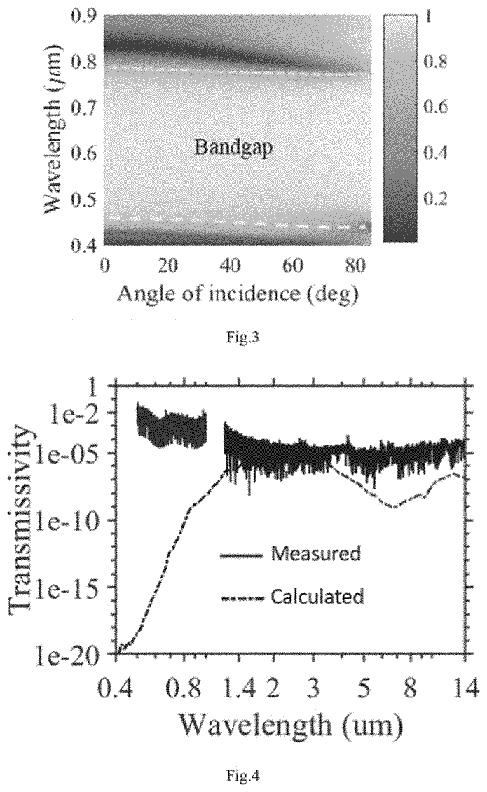

FIG. 3 show the simulated photonic bandgap of the first Bragg grating layer of AITE, the broad bandgap covering the visible light wavelength zone means that all the visible light would be reflected.

As seen from FIG. 4, AITE has almost zero transmission due to high light reflection of Ni₈₀Cr₂₀, so perfect absorption appears at |Z_{ATTE}−Zₐᵢᵣ|=0, wherein Z_{AITE} is characteristic impedance of AITE. FIG. 4 also illustrate that the experimental result follows the simulated curve.

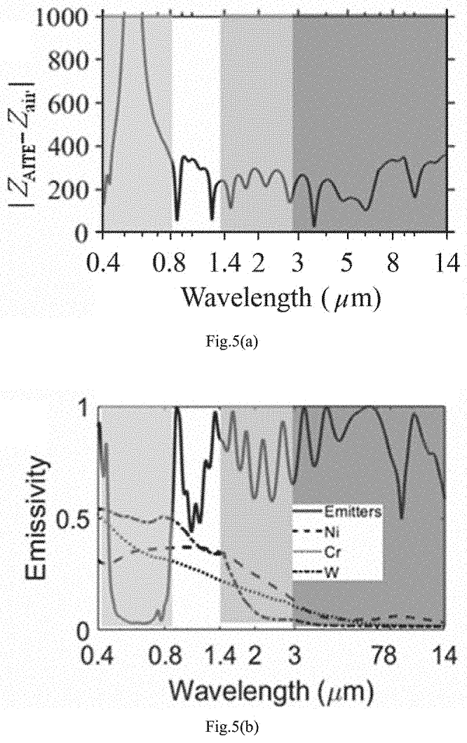

FIG. 5(a) shows the simulated characteristic impedance difference |Z_{AITE}−Zₐᵢᵣ| of AITE, wherein the values of Z_{AITE} and Zₐᵢᵣ are calculated through formula (1). Three wavelength zones of visible light zone (about 0.4-0.8 μm), mid infrared (IR-B) zone (about 1.4-3 μm) and far infrared (IR-C) zone (higher than 3 μm) are indicated respectively, and the characteristic impedance difference at wavelengths longer than 1 μm is much smaller than that of 0.4 μm to 0.8 μm, indicating infrared emission dominates visible emission.

This is further verified through the emissivity spectrum of the AITE in comparison with infrared thermal emitters of common refractory metal, such as tungsten, Nickle and chromium, as shown in FIG. 5(b). The emissivity spectrum is calculated by transfer matrix method (TMM) disclosed in etc., “Broadband absorption engineering of hyperbolic metafilm patterns”, Sci. Rep., 4,4498(2014). In contrast to typical refractory metals (such as tungsten, nichrome, and nickel) that normally have very low thermal emission at infrared wavelengths and high thermal emission at visible wavelengths, ATTE can significantly enhances emissivity at ultrabroad infrared wavelengths range and effectively reduce emissivity at visible band. The average emissivity from 1.4 μm to 14 μm is >0.8.

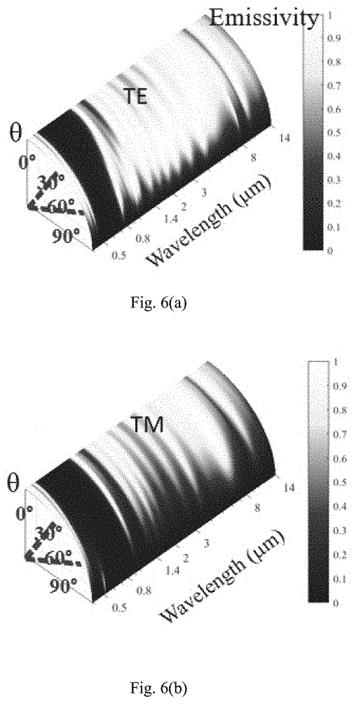

Transfer matrix method is used to calculate spectral absorptivity, whereby directional spectral emissivity ε(θ, λ) for both TE and TM polarization respectively can be obtained, as seen from FIGS. 6(a) and 6(b), where θ represents polar angle. According to Kirchhoff's law, spectral emissivity of the AITE equals to the absorptivity averaged over both the TE and TM polarization. The emissivity has no azimuthal dependence, only polar angle dependence occurs. The spectral absorptivity at different light incidence angles from 0 degree to 80 degree are calculated. It can be noted that both TE and TM polarized lights experience high absorption at ultrabroad spectral and angular ranges. They behave slightly differently when angle of incidence increases: for TE polarization, absorptivity becomes smaller at IR-B and IR-C regions and remains low at visible wavelengths; for TM polarization, absorptivity keeps high at IR-B and IR-C region and low at visible range, and the low absorption bandgap shifts to shorter wavelengths.

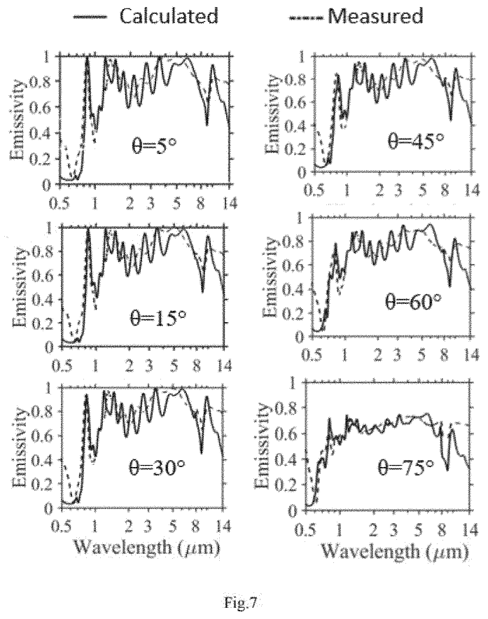

FIG. 7 compares the calculated and measured emissivity spectra at different angle. The calculated emissivity spectra were obtained by averaging above-mentioned TE- and TM-polarized absorptivity, while the measured emissivity spectra were achieved by using un-polarized light source, and emissivity was obtained from measurements of variable angle specular reflectance via Kirchhoff's Law. It is noted from FIG. 7 that the experiential results agree well with theoretical prediction.

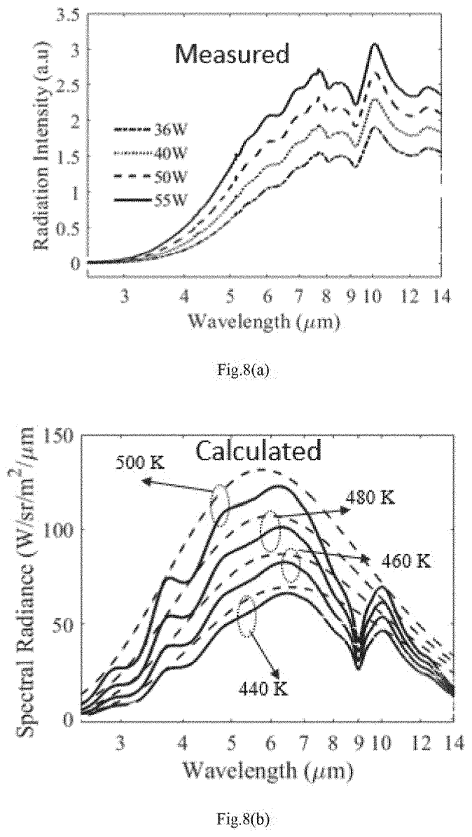

Greatly enhanced infrared light emissivity can be achieved in IR-B and IR-C zone, especially in the IR-C zone, in a broad range of temperature, and this can be verified in FIG. 8 (a). Different input electrical power causes different temperature. When the input electric power is 55 W, the temperature will be about 500K, and the relation between the input electric power and temperature is shown in FIG. 9. FIG. 8(b) illustrate the calculated spectral radiance of AITE (solid line) and blackbody (dotted line) in relation to wavelength at various temperature from room temperature to 500K. FIG. 8 (b) illustrates similar curve trend, indicating that thermal emission measured from the samples agree well with calculations and demonstrates the suppression of emission visible and enhance of emission in IR, and it also demonstrate that the AITE has a similar structure with idea blackbody.

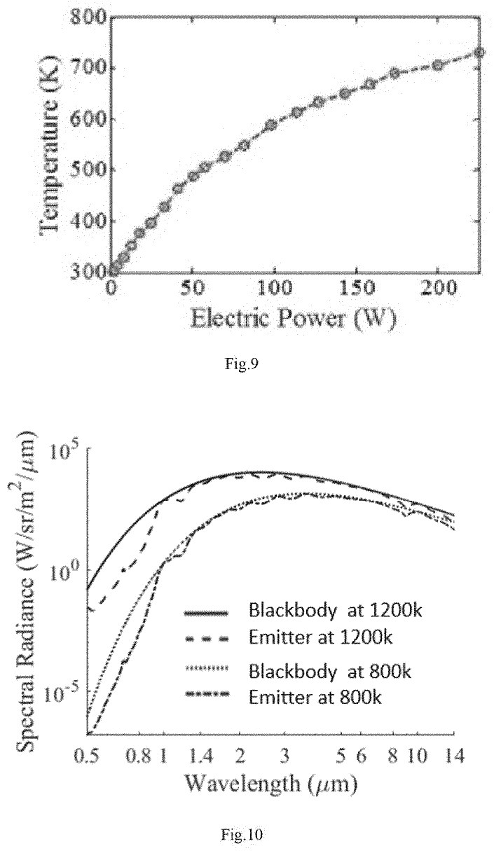

FIG. 10 shows calculated spectra radiance at temperature 800K and 1200K, respectively. It can be seen that the device spectra radiance is close to idea blackbody performance at the same temperature, but it can effectively depress visible radiation comparing to the idea blackbody. The proposed nanophotonic thermal emitter is optically and thermally stable at temperature >900 k.

As demonstrated above, comparing to the existed emitters, the infrared thermal emitters disclosed in the present disclosure have unique advantage of greatly enhancing infrared light emissivity and significantly suppressing visible light radiation simultaneously. In addition, it is in a structure of one dimensional multiple thin films, thus is easy of fabrication and is suitable large scale production for real commercial applications.

Although the present invention has been disclosed in the form of preferred embodiments and variations thereon, it will be understood that the invention is not limited to such disclosed embodiments. Rather, any number of variations, alterations, substitutions or equivalent arrangements might be made thereto without departing from the scope of the invention. Additionally, while various embodiments of the invention have been described, it is to be understood that aspects of the invention may include only some of the described embodiments.

What is claimed is:

1. A nanophotonic infrared thermal emitter, comprising:
a first Bragg Grating layer comprising a first film and a second film stacked alternately, wherein the first film and the second film has a refractive index difference greater than 1.5;
a second Bragg Grating layer comprising a film of silicon and a film of chromium stacked in a structure of (Si/Cr/Si)ⁿ, where n is an integer and represents a number of repeating period; and
a heater layer;
wherein the first Bragg Grating layer, second Bragg Grating layer and the heater layer are stacked sequentially from top to down.

2. The nanophotonic infrared thermal emitter according to claim 1, wherein the first film has a refractive index smaller than 1.5, and the second film has a refractive index greater than 3.

3. The nanophotonic infrared thermal emitter according to claim 1, wherein the first film is a film of silicon dioxide, and the second film is a film of silicon.

4. The nanophotonic infrared thermal emitter according to claim 3, wherein the film of silicon dioxide is configured on the top.

5. The nanophotonic infrared thermal emitter according to claim 1, wherein the first Bragg Grating layer has a structure of (first film/second film)′n, where m is an integer and represents a number of repeating period.

6. The nanophotonic infrared thermal emitter according to claim 5, wherein m is selected from 3 to 6.

7. The nanophotonic infrared thermal emitter according to claim 5, wherein m is 4.

8. The nanophotonic infrared thermal emitter according to claim 1, wherein the heater layer is made of high-resistance metal.

9. The nanophotonic infrared thermal emitter according to claim 8, wherein the heater layer is made of Ni₈₀Cr₂₀.

10. The nanophotonic infrared thermal emitter according to claim 1, wherein the heater layer has a thickness of more than 100 nm.

11. The nanophotonic infrared thermal emitter according to claim 10, wherein the heater layer has a thickness of 300 nm.

12. The nanophotonic infrared thermal emitter according to claim 1, wherein in the first Bragg Grating layer, the first film has a thickness from 70 to 100 nm, and the second film has a thickness from 25 to 50 nm.

13. The nanophotonic infrared thermal emitter according to claim 12, wherein in the first Bragg Grating layer, the first film has a thickness of 90 nm, and the second film has a thickness of 35 nm.

14. The nanophotonic infrared thermal emitter according to claim 1, wherein in the second Bragg Grating layer, the film of silicon has a thickness from 80 to 100 nm, and the film of chromium has a thickness from 3 to 7 nm.

15. The nanophotonic infrared thermal emitter according to claim 1, wherein in the second Bragg Grating layer, the film of silicon has a thickness of 90 nm, and the film of chromium has a thickness of 5 nm.

16. The nanophotonic infrared thermal emitter according to claim 1, wherein in the second Bragg Grating layer, n is selected from 4 to 8.

17. The nanophotonic infrared thermal emitter according to claim 1, wherein in the second Bragg Grating layer, n is 6.

18. An infrared thermal emitting system, comprising:
a nanophotonic infrared thermal emitter, comprising:
a first Bragg Grating layer comprising a first film and a second film stacked alternately, wherein the first film and the second film has a refractive index difference greater than 1.5;
a second Bragg Grating layer comprising a film of silicon and a film of chromium stacked in a structure of (Si/Cr/Si)ⁿ, where n is an integer and represents a number of repeating period;
a heater layer;
an electrode, connected to either of the two sides of the heater layer; and
a substrate;
wherein the first Bragg Grating layer, second Bragg Grating layer, the heater layer and the substrate are stacked sequentially from top to down.

19. The nanophotonic infrared thermal emitting system according to claim 18, wherein the thermal insulator substrate is made of silicon dioxide.

20. An infrared heating method, comprising:
providing, a nanophotonic infrared thermal emitter comprising:
a first Bragg Grating layer comprising a first film and a second film of silicon arranged alternately, wherein the first film and the second film has a refractive index difference greater than 1.5;
a second Bragg Grating layer comprising a film of silicon and a film of chromium stacked in a structure of (Si/Cr/Si)ⁿ, where n is an integer and represents a number of repeating period; and
a heater layer;
wherein the first Bragg Grating layer, second Bragg Grating layer and the heater layer are stacked sequentially from top to down; and
supplying, an electric current to the heater layer.
